(19) United States
(12) Patent Application Publication
(10) Pub. No.: US 2006/0067569 A1
(43) Pub. Date: Mar. 30, 2006

(54) Image inspection device, image inspection method, and image inspection program

(75) Inventor: Susumu Haga, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/234,409

(22) Filed: Sep. 26, 2005

(30) Foreign Application Priority Data
Sep. 29, 2004 (JP) 2004-284776

(51) Int. Cl. G06K 9/00; H04N 17/00

(52) U.S. Cl. 382/141; 348/187

(57) ABSTRACT

When a shading characteristic prepared in advance and the shading characteristic of imaging equipment for inspection differ, there has been the problem that erroneous judgments occur. So a defect detection method is provided. The method includes dividing a digital image, formed from M rows and N columns of pixels, into a plurality of band-shaped areas by partitioning at each of a prescribed number of rows; averaging, for each column, the gradation values of pixels in said band-shaped areas for each of said plurality of band-shaped areas; computing an approximation line which approximates, in each of said plurality of band-shaped areas, a distribution of said average of gradation values; and judging whether there exists a succession of d columns at which the difference between said gradation value derived from said approximation line and said average of gradation values for each column exceeds a prescribed threshold.

### BACKGROUND OF THE INVENTION

1. Field of the Invention

This invention relates to an image inspection device, image inspection method, and image inspection program to perform inspections of image elements.

2. Description of the Related Art

In recent years, CCDs (Charge Coupled Devices), CMOS (Complementary Metal Oxide Semiconductor) devices and other image-capture elements have come to be used in imaging equipment such as digital cameras, digital camcorders, and scanners, use of which is expanding due to their implementation to portable telephones and to declining costs and improved image quality. In quality inspections of imaging equipment equipped with such image-capture elements, the quality (pass or fail) of the image-capture element is judged based on a captured image of a test pattern.

One cause of “fail” results is a defect called a “blemish” (also called a brightness unevenness), in which an area appears such that the difference with the density of the surrounding area is equal to or greater than a prescribed value In manual operation to detect blemishes, a human inspector can inspect captured images visually; but there is variation in the precision of the detection according to the skill of the inspector and his physical condition, the speed of processing differs, and in some cases the problem arises that erroneous judgments are made, with failed items being judged to pass, and passing items failing. Moreover, a substantial amount of time and expense are required to train a skilled inspector. Hence methods have been proposed in the technology of the prior art to automatically inspect for such blemishes.

In general, a captured image may have shading characteristics in which for example the gradation values are bright in the center portion and are darker moving toward the periphery, due to the lens characteristic, illumination characteristic or other factors. When inspecting an image with a pronounced shading characteristic, which in the above example would be an image with a large gradation difference in the center portion and in the peripheral portion, any “faint blemishes” at a level lower than the gradation difference due to shading are hidden by the shading characteristic, so that detection is difficult.

In the prior art, if the shading characteristic in a previously captured image is known, a method has been adopted in which the shading is corrected, smoothing is performed to uniformly correct the image level, and automatic detection of “blemishes” is then performed. For example, Japanese Patent Laid-open No. H9-329527 proposes a method in which, after smoothing, pixel values in differential image data are used to determine the centers of dark defect areas and bright defect areas as well as the positions of the vertices of quadrangles circumscribing these areas, and the positional relationships are used to detect ring-shaped bright defects and ring-shaped dark blemishes.

As peripheral technology, Japanese-Patent Laid-open No. 2003-130756 describes an optical member inspection method in an image inspection apparatus for inspection of the quality of lenses and other optical members, in which filtering using a Fourier transform is performed and gradation patterns appearing periodically in a captured image are removed. And, Japanese Patent Laid-open No. 2003-169255 describes the computation of correction approximation lines for each axis, based on sampling point data on the horizontal and vertical axes passing through the center point of a captured image. It also tells calculation of shading correction coefficients at arbitrary coordinates in the captured image as a product of correction coefficients for correction approximation lines on the horizontal axis and that for correction approximation lines on the vertical axis. Japanese Patent Laid-open No. H7-154675 describes a capture apparatus which changes the size of the block in which data is detected in each area on a screen, and can improve the correction accuracy of shading correction and other processing.

### SUMMARY OF THE INVENTION

However, in the above-described technology of the prior art, shading characteristics prepared in advance can be used to correct an image and enable automatic detection of “blemishes” when the shading characteristic in a captured image is known; but in actuality, due to lens mounting errors and other scattering occurring at the time of equipment manufacture, shading characteristics cannot be determined for uniform application to all imaging equipment for inspection. Consequently when the shading characteristics prepared in advance differ from the shading characteristics of imaging equipment for inspection, acculate correction cannot be performed, and so there are the problems that the accuracy of defect detection is reduced and erroneous judgments occur.

Hence an object of this invention is to provide an image inspection device, image inspection method, and image inspection program capable of automatically detecting “blemishes” in accordance with shading characteristics which differ among imaging equipment for inspection.

As a first aspect of this invention, the above object is achieved by providing a defect detection method, executed by an image inspection device which is connected to imaging equipment having an optical member and an imaging element to convert light received by said optical member into electrical signals, into which is input data of images captured by said imaging equipment, and which detects defects of said imaging equipment based on the image data. The method includes: dividing a digital image, formed from M rows and N columns (where M and N are natural numbers) of pixels, into a plurality of band-shaped areas by partitioning at each of a prescribed number of rows; averaging, for each column, the gradation values of pixels in said band-shaped areas for each of said plurality of band-shaped areas; computing an approximation line which approximates, in each of said plurality of band-shaped areas, a distribution of said average of gradation values; and judging whether there exists a succession of d columns (where d is a natural number satisfying 1<d<N) at which the difference between said gradation value derived from said approximation line and said average of gradation values for each column exceeds a prescribed threshold.

As a second aspect of this invention, the above object is achieved by providing a defect detection method, executed by an image inspection device which is connected to imaging equipment having an optical member and an imaging element to convert light received by said optical member into electrical signals, into which is input data of images captured by said imaging equipment, and which detects defects of said imaging equipment based on the image data. The method includes: dividing a digital image, formed from M rows and N columns (where M and N are natural numbers) of pixels, into a plurality of band-shaped areas by partitioning at each of a prescribed number of rows; averaging, for each column, the gradation values of pixels in said band-shaped areas for each of said plurality of band-shaped areas; computing an approximation line which approximates, in each of said plurality of band-shaped areas, a distribution of said average of gradation values; and judging, in a first band-shaped area among said plurality of band-shaped areas, whether there exists a succession of d columns (where d is a natural number satisfying 1<d<N) at which the difference between said gradation value derived from said approximation line and said average of gradation values for each column exceeds a prescribed threshold, and when such a succession exists, identifying as a position of a defect a portion of said succession of columns at which said difference exceeds said prescribed threshold, and judging whether the position of an defect in an adjacent second band-shaped area overlaps the position of said defect in said first band-shaped area.

As a third aspect of this invention, the above object is achieved by providing a defect detection method, executed by an image inspection device which is connected to imaging equipment having an optical member and an imaging element to convert light received by said optical member into electrical signals, into which is input data of images captured by said imaging equipment, and which detects defects of said imaging equipment based on the image data. The method includes: dividing a digital image, formed from M rows and N columns (where M and N are natural numbers) of pixels, into a plurality of band-shaped areas by partitioning at each of a prescribed number of rows; averaging, for each column, the gradation values of pixels in said band-shaped areas for each of said plurality of band-shaped areas; computing an approximation line which approximates, in each of said plurality of band-shaped areas, a distribution of said average of gradation values; identifying a section of said columns at which the difference of said average of gradation values for each column subtracted from said gradation values derived from said approximation line is positive; and computing, for each of said identified sections, the area enclosed by the distribution of said average of gradation values and by said approximation line, and judging whether said areas in each of said sections exceeds a prescribed threshold.

As a fourth aspect of this invention, the above object is achieved by providing a program executed by a computer which is connected to imaging equipment having an optical member and an imaging element to convert light received by said optical member into electrical signals, into which is input data of images captured by said imaging equipment, and which detects defects of said imaging equipment based on the image data. The program causes the computer to execute: dividing a digital image, formed from M rows and N columns (where M and N are natural numbers) of pixels, into a plurality of band-shaped areas by partitioning at each of a prescribed number of rows; averaging, for each column, the gradation values of pixels in said band-shaped areas for each of said plurality of band-shaped areas; computing an approximation line which approximates, in each of said plurality of band-shaped areas, a distribution of said average of gradation values; and judging whether there exists a succession of d columns (where d is a natural number satisfying 1<d<N) at which the difference between said gradation value derived from said approximation line and said average of gradation values for each column exceeds a prescribed threshold.

As a fifth aspect of this invention, the above object is achieved by providing an image inspection device which is connected to imaging equipment having an optical member and an imaging element to convert light received by said optical member into electrical signals, into which is input data of images captured by said imaging equipment, and which detects defects of said imaging equipment based on the image data, including: a division portion which divides a digital image, formed from M rows and N columns (where M and N are natural numbers) of pixels, into a plurality of band-shaped areas by partitioning at each of a prescribed number of rows; an averaging portion which averages, for each column, the gradation values of pixels in said band-shaped areas for each of said plurality of band-shaped areas; an approximation portion which computes an approximation line which approximates, in each of said plurality of band-shaped areas, a distribution of said average of gradation values; and a judgment portion which judges whether there exists a succession of d columns (where d is a natural number satisfying 1<d<N) at which the difference between said gradation value derived from said approximation line computed by said approximation portion, and said average of gradation values computed by said averaging portion, exceeds a prescribed threshold.

By means of this invention, blemishes can be detected appropriately according to different shading characteristics for each imaging equipment unit in which an imaging element is installed. Hence in inspections there is no need to set shading characteristics identified in advance, and there is no longer a need for strict installation in imaging equipment of a signal capture device which relays signals from the imaging equipment to an image detection device.

### BRIEF DESCRIPTION OF THE DRAWINGS

FIG. 1 explains the configuration of an image inspection system of an embodiment of the invention;

FIG. 2 explains the configuration of an image inspection device of an embodiment;

FIG. 3 is a functional block diagram explaining the control portion of the image inspection device of an embodiment;

FIG. 4 is an example of the data configuration of a captured image;

FIG. 5A is an example of a band-shaped area in a case in which, as the prescribed number of rows, division is performed for every three rows;

FIG. 5B is an example of the data configuration when computed average data for gradation values is stored in a storage portion;

FIG. 6 is a flowchart which explains the operation of an image inspection device of an embodiment;

FIG. 7 is a flowchart which explains a (first) blemish detection method;

FIG. 8 is a flowchart which explains a (second) blemish detection method;

FIG. 9 is a flowchart which explains a (third) blemish detection method;

FIG. 10A is an example of a captured image when there is no blemish;

FIG. 10B shows the distribution of gradation values in a band-shaped area;

FIG. 11A is an example of a captured image when there is one blemish;

FIG. 11B shows the distribution of gradation values in a band-shaped area;

FIG. 12A is an example of a captured image when there are two blemishes;

FIG. 12B shows the distribution of gradation values in a band-shaped area;

FIG. 13A is an example of a captured image when there are two blemishes;

FIG. 13B shows the distribution of gradation values in a band-shaped area when the width is increased; and,

FIG. 14 is an enlarged drawing of the gradation value distribution near a blemish.

### DESCRIPTION OF THE PREFERRED EMBODIMENTS

Below, embodiments of the invention are explained referring to the drawings. However, the technical scope of the invention is not limited to these embodiments, but extends to the inventions described in the scope of claims, and to inventions equivalent thereto.

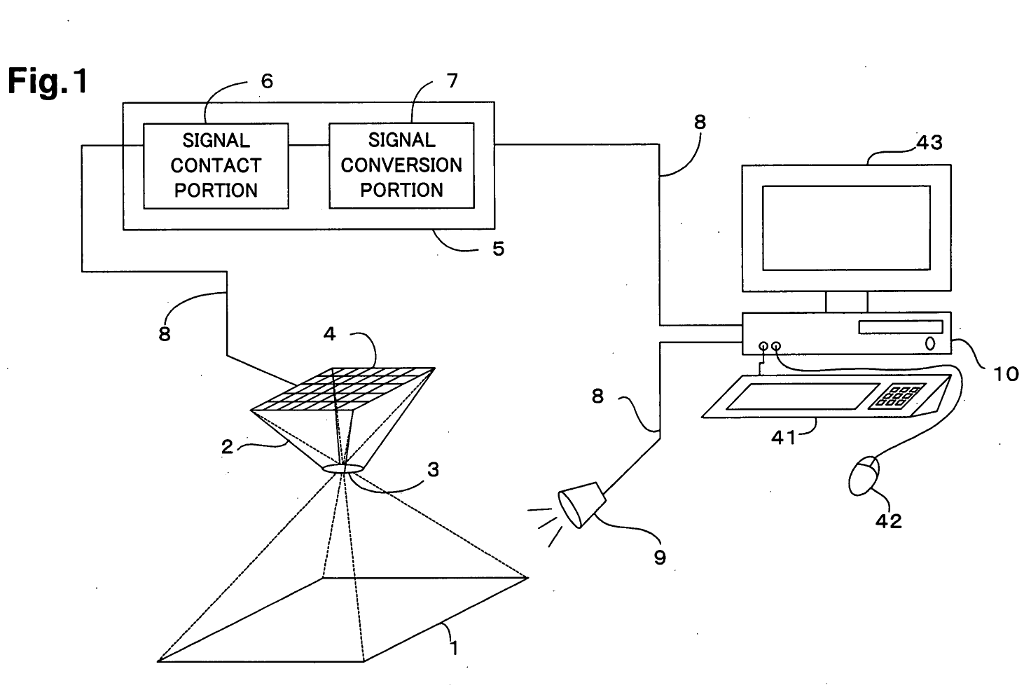

FIG. 1 explains the configuration of an image inspection system of an embodiment of the invention. The image inspection system has a camera unit 2 which captures the capture image 1 for inspection with the imaging element which is to be inspected, a signal input device 5 which converts electrical signals from the camera unit 2 into an image format, and an image inspection device 10 into which image data from the signal input device 5 is input, and which performs detection of blemishes based on this image data; these portions are connected by the signal line 8.

The camera unit 2 includes a lens 3 and a CCD, CMOS device or other imaging element 4 onto which an image is focused by the lens 3. The camera unit 2 captures a capture image 1 for inspection irradiated by light from an illumination device 9. The camera unit 2 is connected via the signal line 8 to a signal input device 5, and electrical signals converted from the light received by the imaging element 4 are input to the signal contact portion 6 of the signal input device 5.

The camera unit 2 is connected to the signal input device 5 by a connection terminal of the signal contact portion 6 which enables the camera unit 2 to be attached or detached, and by a connection terminal of the camera unit 2, in a design enabling inspection of a plurality of imaging elements 4 by detaching and exchanging the camera unit 2. Electrical signals input to the signal contact portion 6 are converted in the signal conversion portion 7 into one among various image formats, such as the RAW image format, TIFF (Tag Image File Format), JPEG (Joint Photographic Experts Group), GIF (Graphic Interchange Format), and BMP (Bit MaP), and is then input as image data to the image inspection device 10.

The image inspection device 10 shown in FIG. 1 is the main portion of a desktop PC, and is connected to a keyboard 41, mouse 42 or other input device, a liquid crystal display 43 or other output device, and to the illumination device 9. The image inspection device 10 displays the image data output from the signal input device 5 on the liquid crystal display 43 as a captured image, displays the results of detection of blemishes based on image data on the liquid crystal display 43, and controls the illumination device 9. In addition, the image inspection device 10 changes settings related blemish detection in response to commands input by an operator via the keyboard 41 or similar.

The image inspection device 10 of this embodiment divides the image data of the captured image into a plurality of band-shaped areas, computes the distribution of gradation values for each band-shaped area, and calculates an approximation line which approximates the distribution of gradation values. Then, based on the difference between the actual gradation values and the approximating values derived from the approximation lines, the presence of blemishes is detected. By this means blemishes can be detected appropriately according to different shading characteristics for each camera unit 2 caused by errors in installation of the lens 3, the quality of the imaging element 4, tolerance during camera unit manufacture, and similar in the camera unit 2.

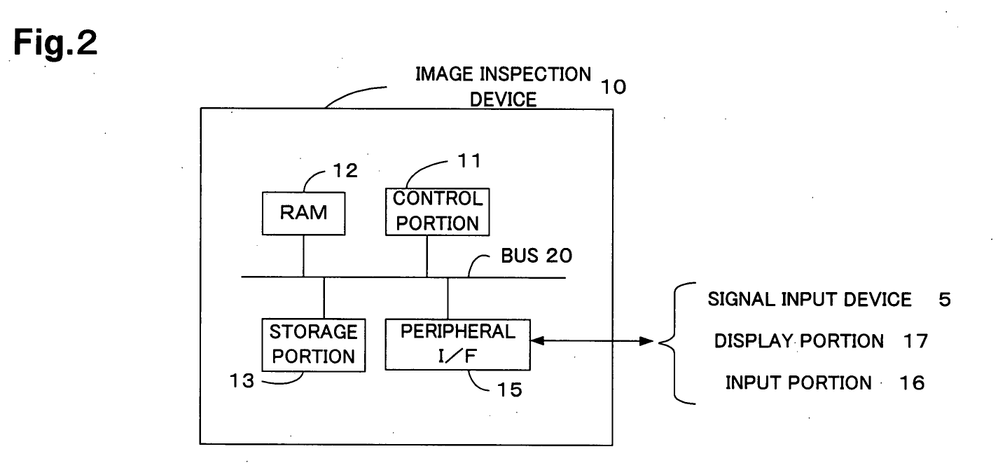

FIG. 2 explains the configuration of the image inspection device 10 of the embodiment. The image inspection device 10 in FIG. 2 is the main portion of a desktop PC, and has a control portion 11, RAM (Random Access Memory) 12, a storage portion 13, and an interface for connection of peripheral equipment (peripheral equipment I/F) 15, all connected by a bus 20.

The control portion 11 includes a CPU (Central Processing Unit), not shown, which executes a program stored in RAM 12 and controls each of the portions in the image inspection device 10. The RAM 12 is storage means in which computation results of processing by the image inspection device 10 and a program are stored temporarily. The storage portion 13 is a hard disk, optical disc, magnetic disk, flash memory, or other non-volatile storage means, and stores various data and an OS (Operating System) or other programs which are to be read into RAM.

The peripheral equipment I/F 15 is an interface for connection of peripheral equipment to the server 1, and may be a USB (Universal Serial Bus) port, a PCI card slot or similar. A broad range of peripheral equipment may be connected, including a printer, TV tuner, SCSI (Small Computer System Interface) equipment, audio equipment, memory card reader/writer, network interface card, wireless LAN card, modem card, keyboard and mouse, and display device. The mode of connection of peripheral equipment to the image inspection device 1 may be wire or wireless.

The input portion 16 is input means to which are input requests from an operator via the keyboard 41, mouse 42, or similar; the display portion 17 is display means such as a CRT (Cathode Ray Tube) or liquid crystal display 43, to provide information to the operator. In this embodiment, the signal input device 5, illumination device 9, input portion 16, and display portion 17 in FIG. 1 are connected via the peripheral equipment I/F 15. When the image inspection device 10 is realized by a notebook PC or other hardware device, a keyboard, a touchpad or other input portion 16, and a liquid crystal display or other display portion 17 may be in the main unit and connected directly to the internal bus 20.

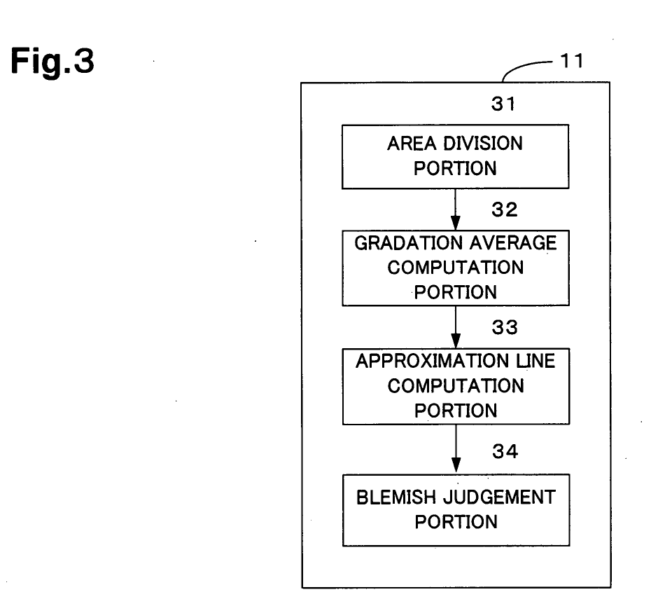

FIG. 3 is a functional block diagram explaining the control portion 11 of the image inspection device 10 of the embodiment. Each of the functional portions of FIG. 3 can be realized either as a program executed by a CPU, not shown, included in the control portion 11, or as an ASIC (Application-Specific Integrated Circuit) or other hardware.

The control portion 11 of FIG. 3 contains an area division portion 31, gradation average computation portion 32, approximation line computation portion 33, and blemish judgment portion 34. The area division portion 31 divides the captured image input to the image inspection device 10 into a plurality of band-shaped areas. Specifically, in preparation for computation of gradation value averages performed in a later stage, gradation value data is acquired for each prescribed area. This operation is explained using the captured image data configuration example described below.

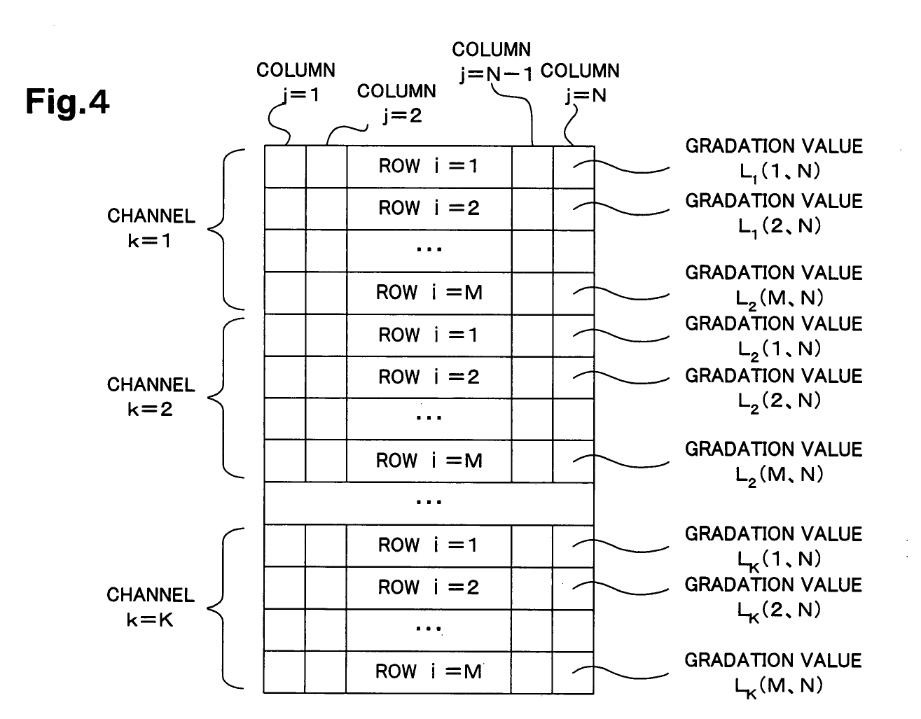

FIG. 4 is an example of the data configuration of a captured image input to the image inspection device 10, and stored in the storage portion 13. Here the captured image is taken to be configured from M rows and N columns of pixels with K channels; in FIG. 4, the captured image is represented by gradation values for each pixel, and the data format is the CSQ (channel sequential) format.

For a monochrome image, the number of channels is 1. An ordinary color image has three channels, corresponding to three primary colors, so that the number of channels is 3. However, in the case of images captured in a plurality of wavelength regions, such as those used in the field of remote sensing, the number of channels may be greater than 3.

The gradation value of a pixel in the ith row, jth column, and kth channel is, in FIG. 4, represented by L_k(i,j) (a character followed by an underscore indicates that the following character is a subscript). The area division portion 31 in FIG. 3 acquires, for each channel, gradation values for a prescribed number of rows, in preparation for computation of the gradation value average, described below. For example, if as the prescribed area the captured image is divided into units of the pixels in three rows and N columns, then the area division portion 31 acquires the initial three rows' worth of gradation values, L_k(1,j), L_k(2,j), L_k(3,j) (1≦j≦N, 1≦k≦K). In the remaining band-shaped areas also, gradation values are obtained for every three rows.

As the number of rows in band-shaped areas, which determines the manner of division, the number of rows set in advance in the storage portion 13 is used. Even if data formats differ, the area division portion 31 acquires data for the number of rows corresponding to the prescribed area.

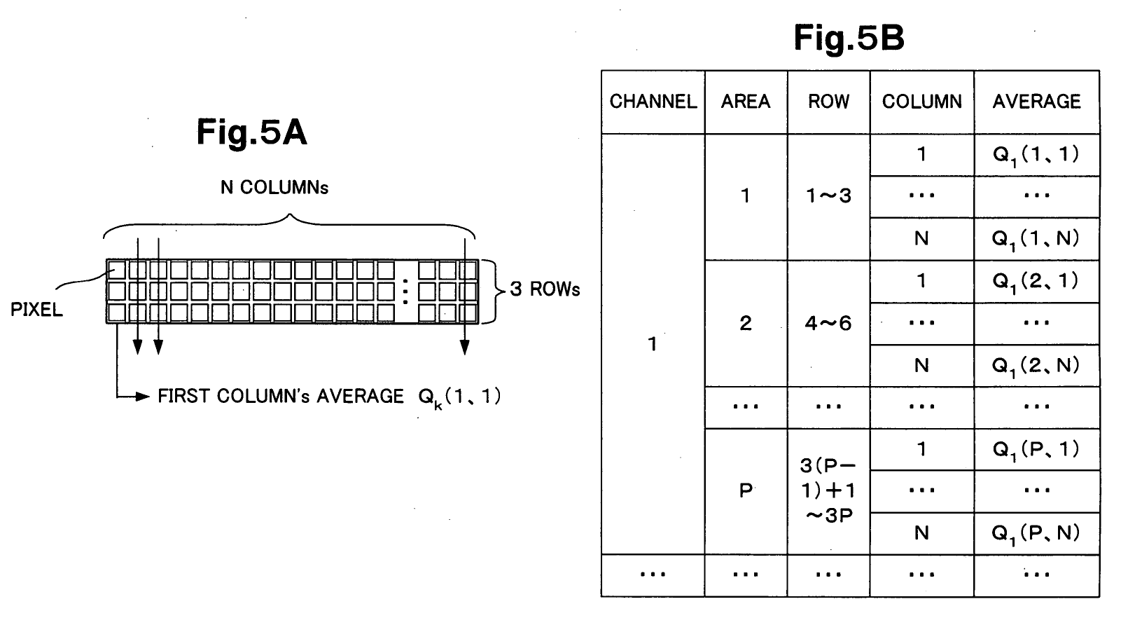

Returning to FIG. 3, the gradation average computation portion 32 computes averages of gradation values for each column in each band-shaped region into which the captured image is divided, based on the data acquired by the area division portion 31. This is explained using FIG. 5A and FIG. 5B.

FIG. 5A is an example of a band-shaped area in a case in which, as the prescribed number of rows, division is performed for every three rows; pixels are extracted for the first three rows and N columns in the kth channel. Each of the pixels in FIG. 5A has a gradation value L_k(i,j) as shown in FIG. 4.

The gradation average computation portion 32 computes the averages of the gradation values for three rows composing each column. For example, if the average gradation value of the jth column in the pth band-shaped area and in the kth channel is represented by Q_k(p,j), then Q_k(1,1) in FIG. 5A is computed from {L_k(1,1)+L_k(2,1)+L_k(3,1)}/3.

The gradation average computation portion 32 performs similar computations for the remaining columns included in the first band-shaped area shown in FIG. 5A, and computes the average of gradation values for each column. The gradation average computation portion 32 then similarly computes averages of gradation values for each column for each of the remaining band-shaped areas. The gradation value average data computed in this way is stored in the storage portion 13.

FIG. 5B is an example of the data configuration when computed average data for gradation values is stored in the storage portion 13. In FIG. 5B, there are the data fields “channel number”, “area number”, “row number”, “column number” and “average gradation value”. As shown in FIG. 5A and FIG. 5B, average gradation values are stored for each column, for each of the plurality of band-shaped areas into which the captured image has been divided, and for each channel.

In FIG. 5B, the captured image is divided into band-shaped areas of three rows by N columns, and so averages of three gradation values included in each column are computed; if band-shaped areas are s rows by N columns, then of course the averages of s gradation values are computed, and are stored as “average gradation values”. When the number of rows in the image cannot be divided by the prescribed number of rows used for division into band-shaped areas without a remainder, then a smaller number of rows than in other band-shaped areas is contained in the edge band-shaped area (for example, with area number P); but the gradation average computation portion 32 similarly computes the average of the gradation values for each column.

Returning to FIG. 3, next the approximation line computation portion 33 computes approximation lines representing the relation between a column number and the average gradation value in each band-shaped area. For example, if column numbers are placed along the x axis and average gradation values are placed along the y axis, and the relation between the two for each band-shaped area is plotted in the two-dimensional plane, the approximation line computation portion 33 computes a set of parameters a, b, c which can be used in the second-degree approximating equation y=ax²+bx+c.

The blemish judgment portion 34 judges whether a blemish is present in the captured image, based on the difference between the average gradation values computed by the gradation value computation portion 32, and the approximating values derived from approximation lines computed by the approximation line computation portion 33, and detects the positions of any blemishes. In this way, the presence of blemishes is judged from image data input to the image inspection device 10, and when blemishes exist, their positions are detected.

Next, operation of the image inspection device, including the method of blemish detection, is explained.

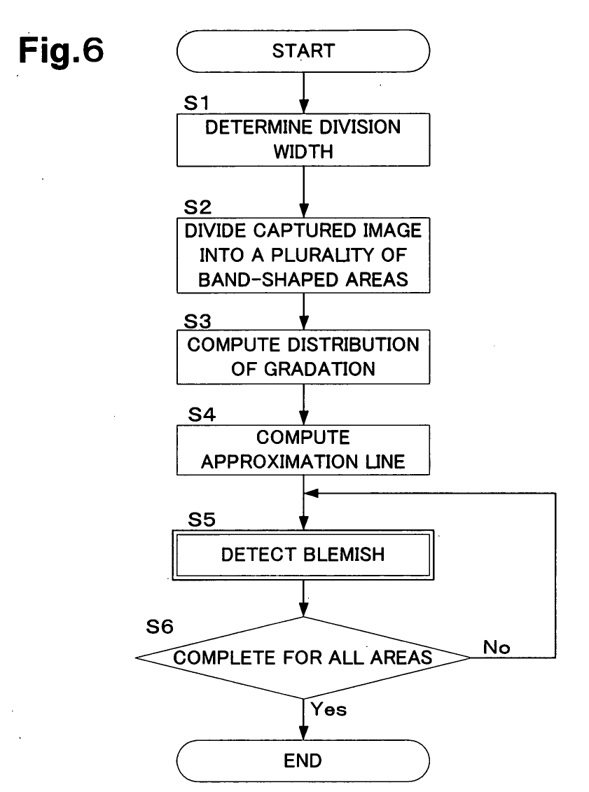

FIG. 6 is a flowchart which explains the operation of the image inspection device 10 of the embodiment. First, the area division portion 31 determines the division width (S1). The division width is the number of rows in a band-shaped area, and is set in advance in the storage portion 13. In step S1, the area division portion 31 reads the set value from the storage portion 13.

Next, the area division portion 31 divides the captured image input to the image inspection device 10 into a plurality of band-shaped areas (S2). In step S2, as explained in FIG. 3, prescribed gradation value data is obtained by the area division portion 31.

Then, the gradation average computation portion 32 computes the distribution of gradations for each band-shaped area (S3). As explained in FIG. 3, the average of gradation values for each column, in each band-shaped area, is computed by the gradation average computation portion 32.

Further, the approximation line computation portion 33 computes approximation lines which approximate the gradation distribution in band-shaped areas (S4). In step S4, as explained in FIG. 3, the approximation line which best represents the relation between a column number and average gradation value in each band-shaped area is computed by the approximation line computation portion 33.

Based on the average gradation values computed in step S3 and the approximation lines computed in step S4, the blemish judgment portion 34 judges whether there are blemishes in the captured image, and if blemishes are present, identifies their positions (S5). The blemish detection method in step S5 is described below. When the image inspection device 10 completes judgment of the presence of blemishes for all band-shaped areas (Yes in S6), processing ends; if there exist band-shaped areas for which judgment has not been performed (No in S6), processing returns to step S5, and processing is continued for the remaining band-shaped areas.

In step S1, the division width is set in advance in the storage portion 13; but the division width may be changed based on past data relating to blemishes detected by the image inspection device 10. That is, in step S1 the area division portion 31 can set the division width, which is the size of the band-shaped areas, to the optimum value according to data relating to blemishes detected as a result of past operation. In other words, by estimating the sizes of blemishes taking into account the division width when blemishes have been detected and whether blemishes were serially detected in adjacent band-shaped areas, the area division portion 31 can set the optimum division width.

Next, an example of processing for blemish detection in step S5 of FIG. 6 is explained.

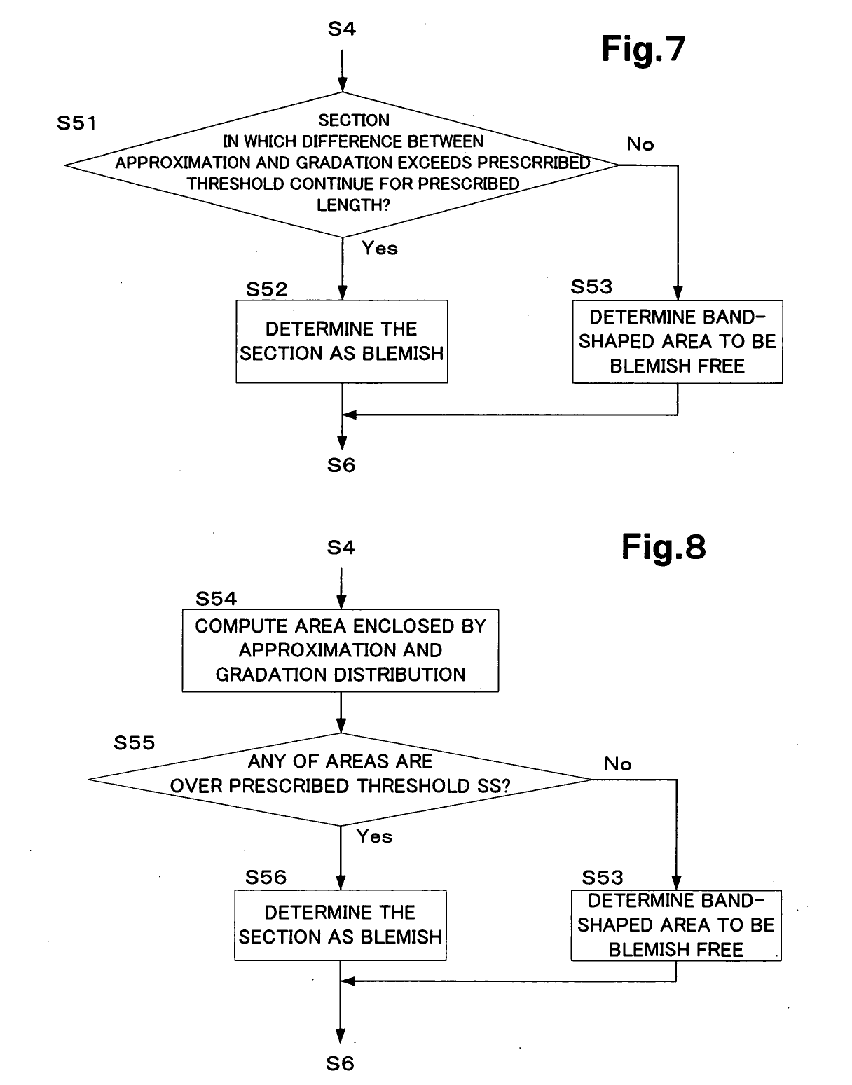

FIG. 7 is a flowchart which explains a (first) blemish detection method. The blemish judgment portion 34, upon completing step S4, judges whether the column numbers of sections in which the difference between the approximate value and the average gradation exceeds a prescribed threshold continue for at least a prescribed length (S51).

The blemish judgment portion 34 takes the difference between the approximation value of gradation values determined by input of column numbers to the approximation function which defines approximation lines, and the average of gradation values in the column corresponding to the input column number. The blemish judgment portion 34 then stores column numbers for which the difference exceeds a prescribed threshold. In this way, the blemish judgment portion 34 determines, for each band-shaped area, the group of column numbers for which the above difference exceeds the prescribed threshold.

Then, the blemish judgment portion 34 judges, in one band-shaped area, whether the column numbers in the above column number group are continuous for the prescribed number (for example, d columns), and if the prescribed number of columns are continuous (Yes in S51), judges a blemish to be present, and stores in the storage portion 13 the column corresponding to the column number of the d columns as the blemish position (S52). For example, if the group of column numbers for which the above difference exceeds the prescribed threshold is {1,2,3,5,6,8,9,10,11}, and if d=3, then it is judged that blemishes exist in the section [1,3] and in the section [8,11].

If the above group of column numbers does not include d continuous columns (No in S51), the blemish judgment portion 34 judges that, for the band-shape area, there are no blemishes (S53). When step S53 ends, processing proceeds to step S6, and by performing similar processing for all band-shaped areas, blemish detection can be performed.

FIG. 8 is a flowchart which explains a (second) blemish detection method. In the detection method explained in FIG. 8, the area enclosed by the approximation line and a graph connecting the averages of gradation vales corresponding to column numbers is used to perform blemish detection.

In FIG. 8, when the blemish judgment portion 34 completes step S4, the areas enclosed by the approximation lies and the gradation distribution are computed (S54). Step S54 is performed through the following processing.

When the difference between the approximation value determined by input of a certain column number to the approximation function, and the gradation value at that column number, is positive, the approximation line at that column number is positioned above the graph, and when the difference is negative, the positional relationship is reversed. The area enclosed by the approximation line and the gradation distribution then corresponds to the sections of column numbers for which the difference is continuously positive and to the sections of column numbers for which the difference is continuously negative, and so in these sections, by taking the sum of the absolute values in the respective sections of the difference obtained by subtracting the gradation value average from the approximation line, the area enclosed by the approximation line and gradation distribution can be determined.

In this way the blemish judgment portion 34 judges whether any of the areas enclosed between the approximation line and the gradation distribution are equal to or exceed the prescribed threshold SS (S55), and judges any sections with column numbers for which the area exceeds the threshold SS to be blemishes (S56). If there are no areas which exceed the prescribed threshold SS, the blemish judgment portion 34 judges the band-shaped area to be free of blemishes (S53). When step S53 is completed, processing proceeds to step S6, and by performing similar processing for all band-shaped areas, blemish detection can be performed.

The cumulative sum of gradation differences computed in step S54, divided by the number of columns included in the corresponding section, may be compared with a newly set threshold SS2 and used in the judgment of step S55. By averaging the gradation differences for each column, when for example the difference with the approximation line is slight, but the graph formed is always below the approximation line, erroneous detection of a blemish can be avoided.

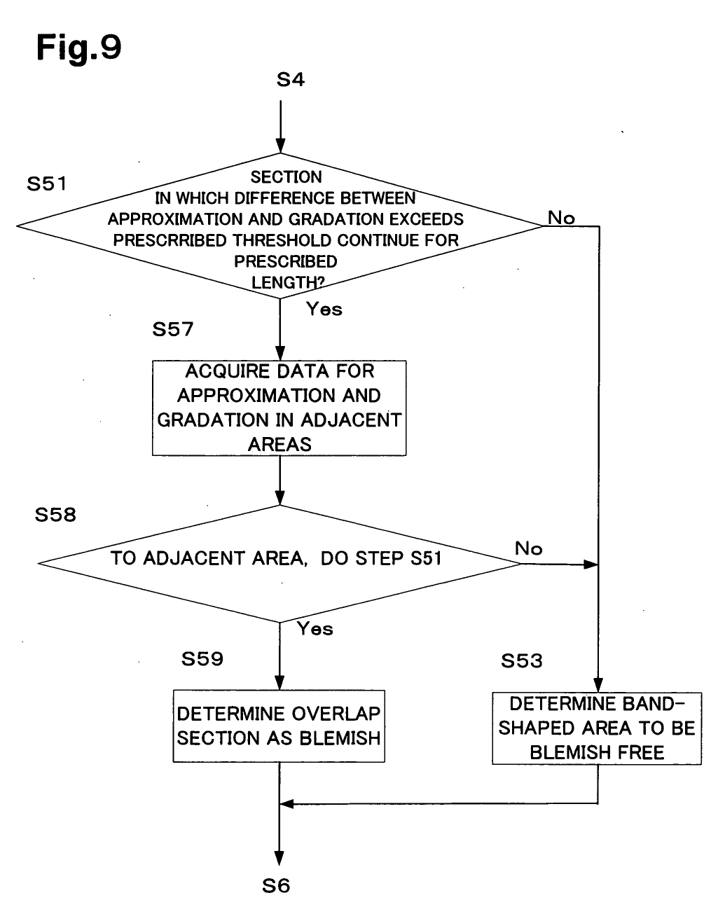

FIG. 9 is a flowchart which explains a (third) blemish detection method. In the detection methods of FIG. 7 and FIG. 8, blemish judgment is performed through judgment for a single band-shaped area; here, through judgments for a plurality of neighboring band-shaped areas, the presence of blemishes is judged. While depending on the width of band-shaped areas, blemishes often span a plurality of band-shaped areas. So if in some band-shaped areas the difference between the approximation value and the average gradation exceeds the prescribed threshold, in adjacent band-shaped areas a similar gradation trend may be observed over a continuous range; hence using this detection method, the presence of such blemishes can be judged rigorously.

In FIG. 9, similarly to FIG. 7, upon completing step S4 the blemish judgment portion 34 judges whether a section in which the difference between approximation values and average gradation values exceeds a prescribed threshold continuous for a prescribed length or longer (S51). For example, as in FIG. 7, in one band-shaped area a judgment is made as to whether the columns in which the difference between the approximation value and the average gradation exceeds a prescribed threshold continue for a prescribed number of columns (for example, d columns). If there is such continuation (Yes in S51), the blemish judgment portion 34 stores the columns corresponding to the column numbers for the d columns in the storage portion 13, and acquires data for the gradation distribution and approximation line in adjacent areas (S57).

For example, when the processing of step S51 is performed for the band-shaped area with area number p (1≦p≦P), the blemish judgment portion 34 obtains the average gradation value and (parameters determining) the approximation function determined in step S4 of FIG. 6, for the band-shaped area with area number p+1 (see FIG. 5B). Next, the blemish judgment portion 34 judges whether the section in which the difference between the approximation value and average gradation exceeds the prescribed threshold continues for the prescribed length or longer, based on data relating to the adjacent area (S58).

If the section continues for the prescribed length (Yes in S58), the blemish judgment portion 34 stores the columns corresponding to the column numbers of the d columns in the storage portion 13, similarly to when the result of step S51 is Yes. Then, when there exists an overlap section of column numbers extending for d columns in the area of adjacency of the band-shaped area addressed in step S51 and the area adjacent thereto, the blemish judgment portion 34 judges a blemish to be present, and stores (the column numbers composing) this overlap section, as the position of a blemish, in the storage portion 13 (S59).

In the case of No in step S51, and in the case of No in step S58, the blemish judgment portion 34 judges the band-shaped area to be blemish-free (S53). When step S53 ends, processing proceeds to step S6, and by performing similar processing for all band-shaped areas, blemishes can be detected.

Below, the manner in which blemishes are detected is explained using a specific example.

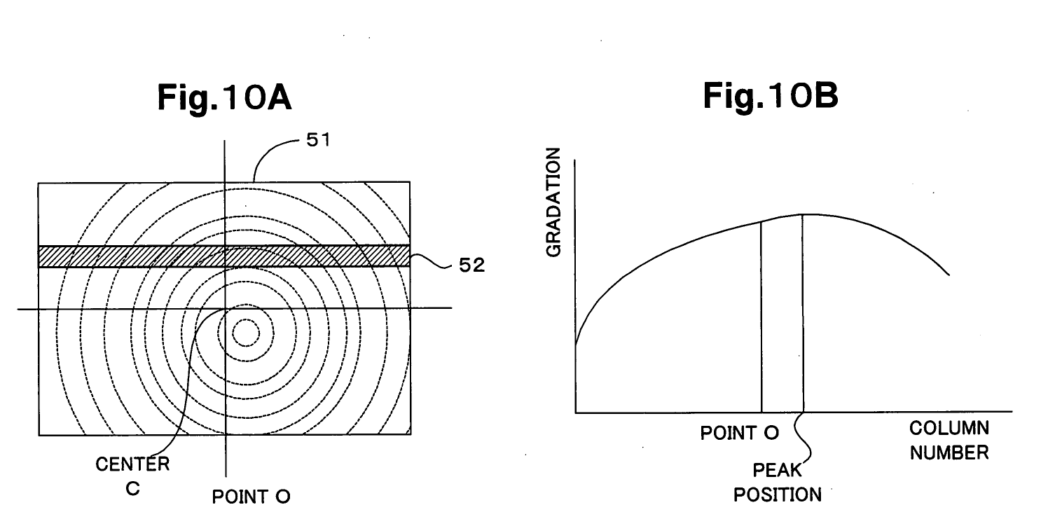

FIG. 10A is an example of a captured image when there is no blemish. Here, for simplicity, an explanation is given for a monochrome image. In a monochrome image, the number of channels is 1, and only a single gradation distribution is needed for each band-shaped area. In the monochrome image shown in FIG. 10A, the center of the shading characteristic is shifted to the lower-right from the center C of the captured image 51.

FIG. 10B shows the distribution of gradation values in a band-shaped area 52 of FIG. 10A. In FIG. 10B, the column number and the gradation value are plotted along the horizontal and vertical axes respectively, and a graph is shown which connects averages of gradation values for each column in the band-shaped area 52, computed in step S3 of FIG. 6. As shown in FIG. 10B, the gradation value peak position is shifted to the right from the point O on the axis passing through the center C, and declines gradually in moving away from this point toward the periphery. Because FIG. 10A is an example of a captured image with no blemishes, the graph shown in FIG. 10B has no peculiar areas other than the tendency for gradation values to rise in moving toward the peak position.

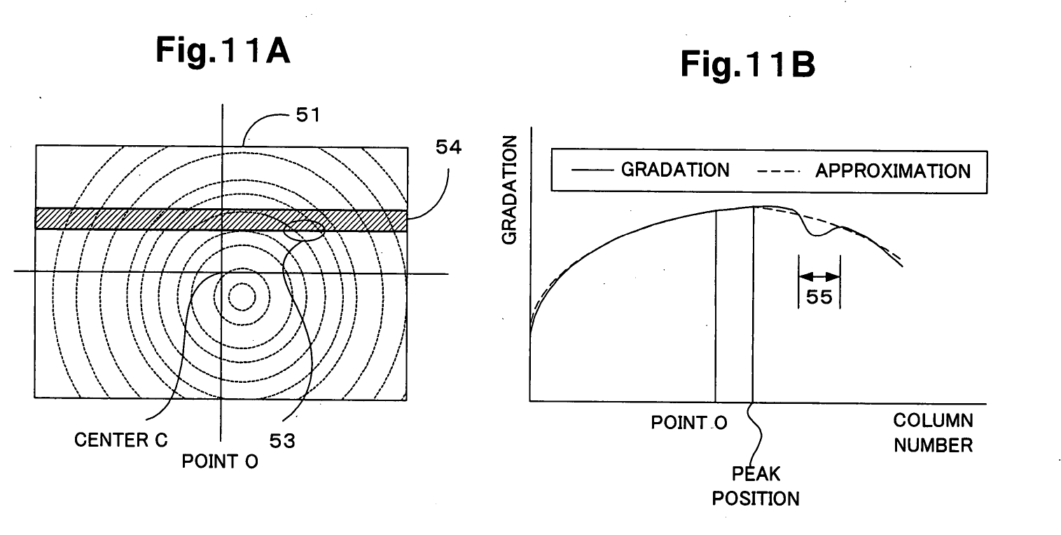

FIG. 11A is an example of a captured image when there is one blemish. In the monochrome image shown in FIG. 11A, the center of the shading characteristic is shifted toward the lower-right from the center C of the captured image 51; in addition, a blemish 53 is seen in a portion of the band-shaped area 54.

FIG. 11B shows the distribution of gradation values in the band-shaped area 54. In FIG. 11B, the graph connecting the averages of gradation values for each column in the band-shaped area 52, computed in step S3 of FIG. 6, is shown as a solid line, and a graph based on the approximation function, computed in step S4 of FIG. 6, is shown as a dashed line. In contrast with FIG. 10B for the case of no blemishes, a site 55 exists in which there is a sharp change in gradation value, at a position corresponding to the blemish 53.

In this embodiment, as shown in FIG. 11A, blemish detection is possible even when the peak position is not the center position. This is because, in the prior art, shading characteristics identified in advance are set so that the shading characteristics appear as specified, but in this embodiment an approximation line is determined in each band-shaped area according to manufacturing tolerances of each camera unit, shifts in the mounting position of signal input device into the camera unit and similar, and judgments are performed based on the difference with the actual gradation values. Hence by performing the processing of FIG. 6 through FIG. 9, the image inspection device 10 of this embodiment can appropriately detect the presence of a blemish at the site 55, based on the difference between the approximation line and the actual gradation values.

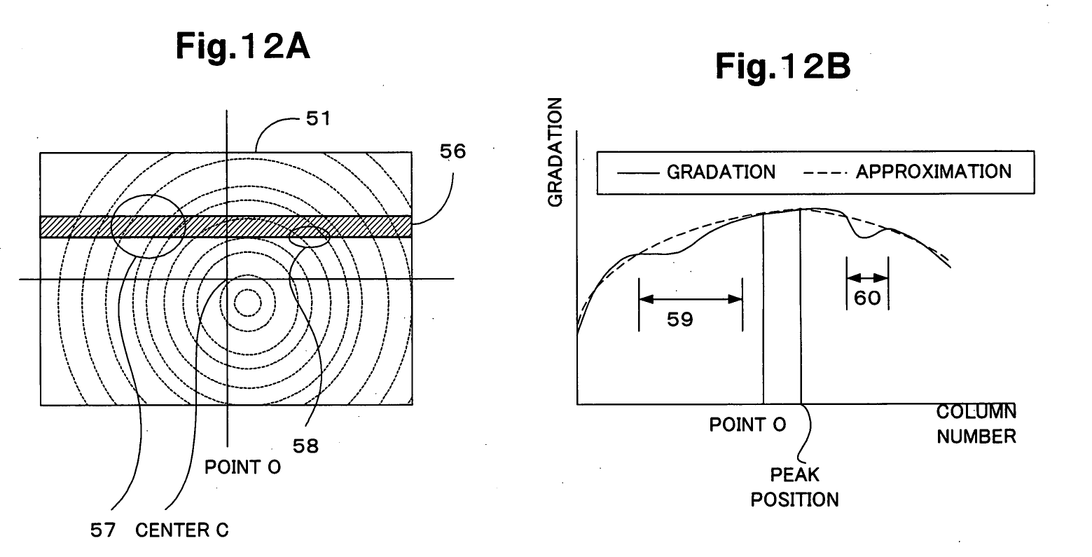

FIG. 12A is an example of a captured image when there are two blemishes. In the monochrome image shown in FIG. 12A, the center of the shading characteristic is shifted to the lower-right from the center C of the captured image 51; in addition, two blemishes 57, 58 are seen in a portion of the band-shaped area 56.

FIG. 12B shows the distribution of gradation values in the band-shaped area 56. In FIG. 12B, the graph formed by connecting the averages of gradation values for each column in the band-shaped area 56, computed in step S3 of FIG. 6, is represented by a solid line; the graph based on the approximation function computed in step S4 of FIG. 6 is represented by the dashed line. In FIG. 12B, there exist sites 59, 60 at which there are abrupt changes in gradation value, on the left and right sides of the peak position, corresponding to the blemishes 57, 58. The image inspection device 10 of this embodiment, by performing the processing of FIG. 6 through FIG. 9, can appropriately detect the presence of blemishes at the sites 59, 60 based on the difference between the approximation line and the actual gradation values, even when there are two blemishes in one band-shaped area.

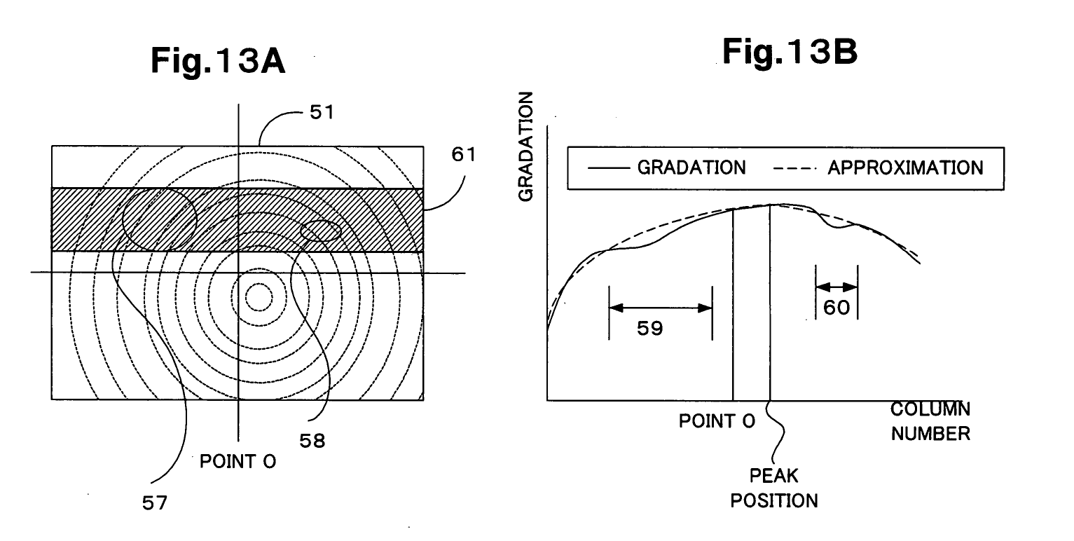

FIG. 13A is an example of a captured image when there are two blemishes, and is the same as FIG. 12A. FIG. 13B shows the distribution of gradation values when a band-shaped area 61 of width larger than the band-shaped area 56 is used. As shown in FIG. 13B, if blemish detection is performed with the band-shaped area width increased, the features of the smaller blemish 58 are obscured by the change in shading characteristic, so that detection of smaller blemishes may be difficult. However, when it is known that larger blemishes will appear, increasing the width of the band-shaped areas enables more efficient blemish detection.

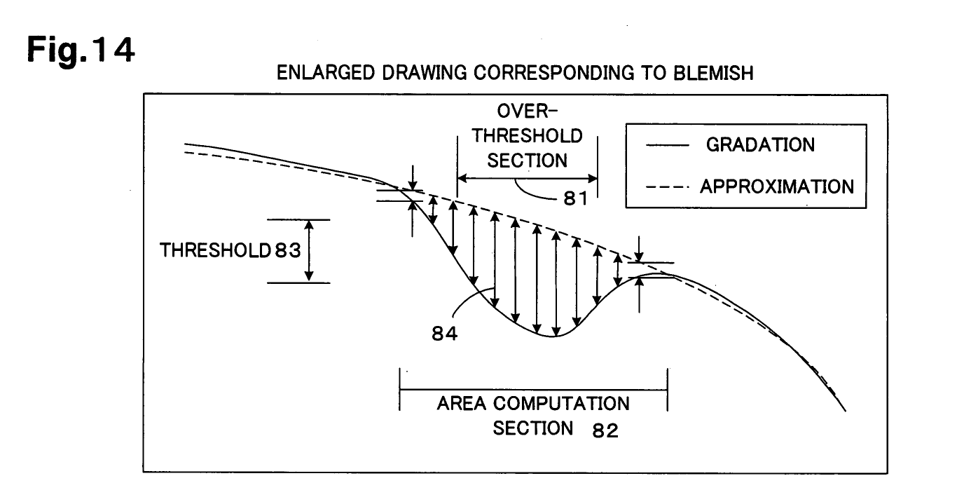

FIG. 14 is an enlarged drawing of the gradation value distribution near the blemish 53 in FIG. 11, used to explain the method of blemish detection of FIG. 7 and FIG. 8. The upward-downward arrows 84 in FIG. 14 indicate the differences in each column between approximated gradation values, determined by input of the column number to the approximation function which defines the approximation line, and the average of the gradation value in the column with the corresponding column number.

The section 81 exceeding the threshold in FIG. 14 is the section in which the difference described above is greater than the prescribed threshold used in step S51 of FIG. 7. That is, if the prescribed threshold is represented by the length of the arrow 83, then this is the section in which the lengths of the arrows 84 are longer than the arrow 83. By means of the detection method explained in FIG. 7, if the section 81 exceeding the threshold continues for d or more columns, then a blemish is judged to be present.

The area computation section 82 is the section over which the difference, obtained by subtracting the average value of gradation values at a column number from the average value computed by input of the column numbers to the approximation function, is continuously positive. In this area computation section 82, if a cumulative sum of the above difference is taken, the area used in step S55 of the detection method explained in FIG. 8 is obtained. If this cumulative sum exceeds the prescribed threshold SS2, then the area computation section 82 shown in FIG. 14 is judged to be a blemish.

As described above, by means of these embodiments, in contrast with technology of the prior art in which blemish detection is performed after making corrections based on shading characteristics stipulated in advance, appropriate detection of blemishes can be performed according to shading characteristics which differ among camera units. Moreover, by means of these embodiments, shading characteristics identified in advance need not be set in order to perform inspections, nor is there a need to install the camera unit 2 in a signal input device 5 (signal contact portion 6) in order that the shading characteristics set in advance may appear.

What is claimed is:

1. A defect detection method, executed by an image inspection device which is connected to imaging equipment having an optical member and an imaging element to convert light received by said optical member into electrical signals, into which is input data of images captured by said imaging equipment, and which detects defects of said imaging equipment based on the image data, said method comprising:
dividing a digital image, formed from M rows and N columns (where M and N are natural numbers) of pixels, into a plurality of band-shaped areas by partitioning at each of a prescribed number of rows;
averaging, for each column, the gradation values of pixels in said band-shaped areas for each of said plurality of band-shaped areas;
computing an approximation line which approximates, in each of said plurality of band-shaped areas, a distribution of said average of gradation values; and
judging whether there exists a succession of d columns (where d is a natural number satisfying 1<d<N) at which the difference between said gradation value derived from said approximation line and said average of gradation values for each column exceeds a prescribed threshold.

2. The defect detection method according to claim 1, further comprising identifying the position of a portion, in each of said plurality of band-shaped areas, in which said columns at which said difference exceeds said prescribed threshold are continuous.

3. A defect detection method, executed by an image inspection device which is connected to imaging equipment having an optical member and an imaging element to convert light received by said optical member into electrical signals, into which is input data of images captured by said imaging equipment, and which detects defects of said imaging equipment based on the image data, said method comprising:
dividing a digital image, formed from M rows and N columns (where M and N are natural numbers) of pixels, into a plurality of band-shaped areas by partitioning at each of a prescribed number of rows;
averaging, for each column, the gradation values of pixels in said band-shaped areas for each of said plurality of band-shaped areas;
computing an approximation line which approximates, in each of said plurality of band-shaped areas, a distribution of said average of gradation values; and
judging, in a first band-shaped area among said plurality of band-shaped areas, whether there exists a succession of d columns (where d is a natural number satisfying 1<d<N) at which the difference between said gradation value derived from said approximation line and said average of gradation values for each column exceeds a prescribed threshold, and when such a succession exists, identifying as a position of a defect a portion of said succession of columns at which said difference exceeds said prescribed threshold, and judging whether the position of an defect in an adjacent second band-shaped area overlaps the position of said defect in said first band-shaped area.

4. A defect detection method, executed by an image inspection device which is connected to imaging equipment having an optical member and an imaging element to convert light received by said optical member into electrical signals, into which is input data of images captured by said imaging equipment, and which detects defects of said imaging equipment based on the image data, said method comprising:
dividing a digital image, formed from M rows and N columns (where M and N are natural numbers) of pixels, into a plurality of band-shaped areas by partitioning at each of a prescribed number of rows;
averaging, for each column, the gradation values of pixels in said band-shaped areas for each of said plurality of band-shaped areas;
computing an approximation line which approximates, in each of said plurality of band-shaped areas, a distribution of said average of gradation values;
identifying a section of said columns at which the difference of said average of gradation values for each column subtracted from said gradation values derived from said approximation line is positive; and
computing, for each of said identified sections, the area enclosed by the distribution of said average of gradation values and by said approximation line, and judging whether said areas in each of said sections exceeds a prescribed threshold.

5. The defect detection method according to claim 4, further comprising identifying said sections in which said areas exceed said prescribed threshold.

6. A program executed by a computer which is connected to imaging equipment having an optical member and an imaging element to convert light received by said optical member into electrical signals, into which is input data of images captured by said imaging equipment, and which detects defects of said imaging equipment based on the image data, the program causes the computer to execute:
dividing a digital image, formed from M rows and N columns (where M and N are natural numbers) of pixels, into a plurality of band-shaped areas by partitioning at each of a prescribed number of rows;
averaging, for each column, the gradation values of pixels in said band-shaped areas for each of said plurality of band-shaped areas;
computing an approximation line which approximates, in each of said plurality of band-shaped areas, a distribution of said average of gradation values; and
judging whether there exists a succession of d columns (where d is a natural number satisfying 1<d<N) at which the difference between said gradation value derived from said approximation line and said average of gradation values for each column exceeds a prescribed threshold.

7. The program according to claim 6, further causing the computer to execute identifying the position of a portion, in each of said plurality of band-shaped areas, in which said columns at which said difference exceeds said prescribed threshold are continuous.

8. A program executed by a computer which is connected to imaging equipment having an optical member and an imaging element to convert light received by said optical member into electrical signals, into which is input data of images captured by said imaging equipment, and which detects defects of said imaging equipment based on the image data, the program causes the computer to execute:
dividing a digital image, formed from M rows and N columns (where M and N are natural numbers) of pixels, into a plurality of band-shaped areas by partitioning at each of a prescribed number of rows;
averaging, for each column, the gradation values of pixels in said band-shaped areas for each of said plurality of band-shaped areas;
computing an approximation line which approximates, in each of said plurality of band-shaped areas, a distribution of said average of gradation values; and
judging, in a first band-shaped area among said plurality of band-shaped areas, whether there exists a succession of d columns (where d is a natural number satisfying 1<d<N) at which the difference between said gradation value derived from said approximation line and said average of gradation values for each column exceeds a prescribed threshold, and when such a succession exists, identifying as a position of a defect a portion of said succession of columns at which said difference exceeds said prescribed threshold, and judging whether the position of an defect in an adjacent second band-shaped area overlaps the position of said defect in said first band-shaped area.

9. A program executed by a computer which is connected to imaging equipment having an optical member and an imaging element which converts light received by said optical member into electrical signals, into which is input data of images captured by said imaging equipment, and which detects defects of said imaging equipment based on the image data, the program causes the computer to execute:
dividing a digital image, formed from M rows and N columns (where M and N are natural numbers) of pixels, into a plurality of band-shaped areas by partitioning at each of a prescribed number of rows;
averaging, for each column, the gradation values of pixels in said band-shaped areas for each of said plurality of band-shaped areas;
computing an approximation line which approximates, in each of said plurality of band-shaped areas, a distribution of said average of gradation values;
identifying a section of said columns at which the difference of said average of gradation values for each column subtracted from said gradation values derived from said approximation line is positive; and
computing, for each of said identified sections, the area enclosed by the distribution of said gradation values and by said approximation line, and judging whether said areas in each of said sections exceeds a prescribed threshold.

10. The program according to claim 9, further causing the computer to execute identifying said sections in which said areas exceed said prescribed threshold.

11. An image inspection device which is connected to imaging equipment having an optical member and an imaging element to convert light received by said optical member into electrical signals, into which is input data of images captured by said imaging equipment, and which detects defects of said imaging equipment based on the image data, comprising:
a division portion which divides a digital image, formed from M rows and N columns (where M and N are natural numbers) of pixels, into a plurality of band-shaped areas by partitioning at each of a prescribed number of rows;
an averaging portion which averages, for each column, the gradation values of pixels in said band-shaped areas for each of said plurality of band-shaped areas;
an approximation portion which computes an approximation line which approximates, in each of said plurality of band-shaped areas, a distribution of said average of gradation values; and
a judgment portion which judges whether there exists a succession of d columns (where d is a natural number satisfying 1<d<N) at which the difference between said gradation value derived from said approximation line computed by said approximation portion, and said average of gradation values computed by said averaging portion, exceeds a prescribed threshold.

12. The image inspection device according to claim 11, further comprising an identification portion which identifies the position of a portion, in each of said plurality of band-shaped areas, in which said columns at which said difference exceeds said prescribed threshold are continuous.

13. An image inspection device which is connected to imaging equipment having an optical member and an imaging element to convert light received by said optical member into electrical signals, into which is input data of images captured by said imaging equipment, and which detects defects of said imaging equipment based on the image data, comprising:
a division portion which divides a digital image, formed from M rows and N columns (where M and N are natural numbers) of pixels, into a plurality of band-shaped areas by partitioning at each of a prescribed number of rows;
an averaging portion which averages, for each column, the gradation values of pixels in said band-shaped areas for each of said plurality of band-shaped areas;
an approximation portion which computes an approximation line which approximates, in each of said plurality of band-shaped areas, a distribution of said average of gradation values; and
a rigorous judgment portion which judges, in a first band-shaped area among said plurality of band-shaped areas, whether there exists a succession of d columns (where d is a natural number satisfying 1<d<N) at which the difference between said gradation value derived from said approximation line computed by said approximation portion, and said average of gradation values computed by said averaging portion, exceeds a prescribed threshold, and when such a succession exists, identifies as a position of a defect a portion of said succession of columns at which said difference exceeds said prescribed threshold, and judges whether the position of an defect in an adjacent second band-shaped area overlaps the position of said defect in said first band-shaped area.

14. An image inspection device which is connected to imaging equipment having an optical member and an imaging element to convert light received by said optical member into electrical signals, into which is input data of images captured by said imaging equipment, and which detects defects of said imaging equipment based on the image data, comprising:
a division portion which divides a digital image, formed from M rows and N columns (where M and N are natural numbers) of pixels, into a plurality of band-shaped areas by partitioning at each of a prescribed number of rows;
an averaging portion which averages, for each column, the gradation values of pixels in said band-shaped areas for each of said plurality of band-shaped areas;
an approximation portion which computes an approximation line which approximates, in each of said plurality of band-shaped areas, a distribution of said average of gradation values; and
an area judgment portion which identifies the section of said columns at which the difference of said average of gradation values computed by said averaging portion subtracted from said gradation values derived from said approximation line computed by said approximation portion is positive, and computes, for each of said identified sections, the area enclosed by the distribution of said average of gradation values and by said approximation line, and judges whether said areas in each of said sections exceeds a prescribed threshold.

15. The defect detection method according to claim 14, further comprising an identification portion which identifies said sections in which said areas exceed said prescribed threshold.
